(19) United States
(12) Patent Application Publication
(10) Pub. No.: US 2003/0193181 A1
(43) Pub. Date: Oct. 16, 2003

(54) DVD storage bag

(76) Inventor: Yeung Shu Hung, Taipei Hsien (TW)

Correspondence Address: PRO-TECHTOR INTERNATIONAL, 20775 Norada Court, Saratoga, CA, 95070-3018, US

(21) Appl. No.: 10/218,476

(22) Filed: Aug. 13, 2002

(30) Foreign Application Priority Data
Apr. 12, 2002 (TW) 091204806

(51) Int. Cl. B42D 1/00

(52) U.S. Cl. 281/15.1

(57) ABSTRACT

A flexible loose-leaf sheet storage element for holding one record disc and its accompanying graphic pages on one side and another record disc and its accompanying graphic pages on the other side, comprises a front transparent sheet, a middle sheet and a back transparent sheet interconnected along their four edges and a substantial midline between their upper and lower edges. Two pockets for receiving record discs and two pockets for receiving their accompanying graphic pages are thus formed.

### BACKGROUND OF THE INVENTION

1. Field of the Invention

This invention relates to a storage element adapted for holding two record discs, more particularly two Digital Video Discs, and their respective accompanying graphic pages. This invention also relates to an assembly of such storage elements.

2. Description of the Related Art

A sleeve for holding Digital Video Discs (hereinafter collectively DVDs) and accompanying graphics is shown in U.S. Pat. No. 6,241,086. The patent teaches a sleeve adapted for holding one or two DVDs and their accompanying graphics, which provides a solution to the problem of arrangement caused by the fact that generally the accompanying graphics have a length much greater than the diameter of the DVDs. However, it has several drawbacks.

First, the DVDs are placed on the reverse side of the sleeve to the side where their accompanying graphics are placed, which is not convenient for a user to identify a DVD via its accompanying graphics and to access the whole set of DVD/graphics. Also, the number of times that the sleeves are turned over will be doubled thus its lifetime is reduced due to accelerated wear-out at the binding portion.

Secondly, in the above-mentioned invention, the discs are placed either toward the upper portion of the sleeve or toward its lower portion. A great difference of thickness will occur between the upper portion and the lower portion of the sleeve when the discs are loaded. Such difference of thickness becomes even more striking and undesirable when multiple sleeves loaded with discs are jointly contained in an album.

Further, in the above-mentioned invention, the openings of the pockets for receiving the discs and for receiving the graphics are disposed in a direction away from the binding border of the sleeve. Such design may allow the discs to inadvertently come off the pockets by a centrifugal force when the sleeve is turned over.

### SUMMARY OF THE INVENTION

It is an object of the present invention to provide a storage element for record discs and their accompanying graphics, which can allow a user to identify a disc with its accompanying graphics and to access the whole set of disc/graphics conveniently. Thus a storage element is provided which comprises on each and every side one pocket for receiving a record disc and another for receiving the graphics accompanying with that disc.

The storage element is mainly comprised of a front transparent sheet, a middle sheet and a back transparent sheet, each of them having an upper edge, a lower edge, a left edge and a right edge. The three sheets are interconnected along their four edges and a substantial midline between their upper and lower edges. Thus, a first disc pocket and a first graphic pocket are juxtaposedly defined between the front transparent sheet and the middle sheet, and a second disc pocket and a second graphic pocket are juxtaposedly defined between the middle sheet and the back transparent sheet. Therefore, a record disc and its accompanying graphics can be placed juxtaposedly on the same side of a storage element, allowing a user to identify a record disc with its accompanying graphics instantly and to access the target disc conveniently.

It is another object of the present invention to provide a storage element for record discs and their accompanying graphics, wherein the impact of the difference of thickness between the portion occupied by a disc and the remaining portion of the disc pocket is alleviated. Thus, a record disc is to be received substantially at the middle portion of each disc pocket so that the remaining portion is divided into two parts each having a reduced width.

To allow inserting and removal of the record disc, a flap cut is formed at the upper middle portion of each disc pocket on its constituent transparent sheet. For each disc pocket, two side stopping seals interconnecting its two constituent sheets are provided to hold the record disc at the middle portion of the oversized disc pocket. To facilitate the manufacturing process, the first disc pocket and the second disc pocket are aligned back to back, whereby the side stopping seals of the two pockets are aligned at same locations thus can be formed during a single process of jointly welding the three sheets.

To allow inserting and removal of the graphics accompanying with the record discs, an elongated opening cut is formed approximate to the upper edge of each graphic pocket on its constituent transparent sheet. Thus, a record disc and its accompanying graphics are inserted into or removed from the pockets in the same direction.

It is a further object of the present invention to provide an album comprising a plurality of the above-mentioned storage elements, which has a reduced overall thickness.

### BRIEF DESCRIPTION OF THE SEVERAL VIEWS OF THE DRAWINGS

FIG. 1 is a pre-assembled perspective view of the constituent sheets of a storage element comprising two disc pockets and two graphic pockets.

FIG. 2 is a front elevation view of the storage element shown in FIG. 1.

FIG. 3 is a front elevation view of the storage element of FIG. 1 shown with disks and graphics inserted in the respective pockets.

FIG. 4 is a front elevation view of an alternative storage element of FIG. 1.

FIG. 5 is a front elevation view of another alternative storage element of FIG. 1.

FIG. 6a is a front elevation view of still another alternative storage element of FIG. 1, wherein the disposition of the disc pockets and the graphic pockets in the storage element is reversed.

FIG. 6b is a back elevation view of the storage element of FIG. 6a.

FIG. 7 is a pre-assembled view of a portion of an album comprising a plurality of identical storage elements arranged in the same direction.

FIG. 8 is a pre-assembled view of a portion of an album comprising a plurality of different storage elements disposed in interposition.

FIG. 9 is a pre-assembled view of a portion of an album comprising a plurality of identical storage elements arranged in pairs each having two storage elements disposed in reverse directions.

### DETAILED DESCRIPTION OF THE INVENTION

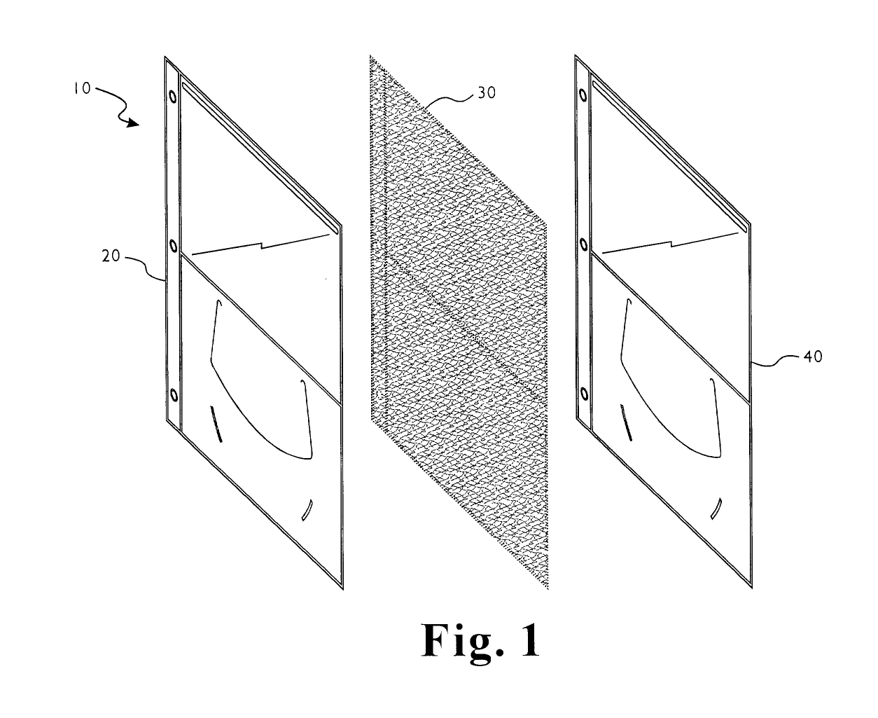

Referring now to the drawings, FIG. 1 is a pre-assembled perspective view of the components of a storage element. The storage element 10 comprises a front transparent sheet 20, a middle sheet 30, and a back transparent sheet 40. Preferably, the front transparent sheet 20 and the back transparent sheet 40 are made of flexible transparent plastic film and the middle sheet 30 of a non-woven fabric. Suitable materials are known in the art and therefore will not be discussed here.

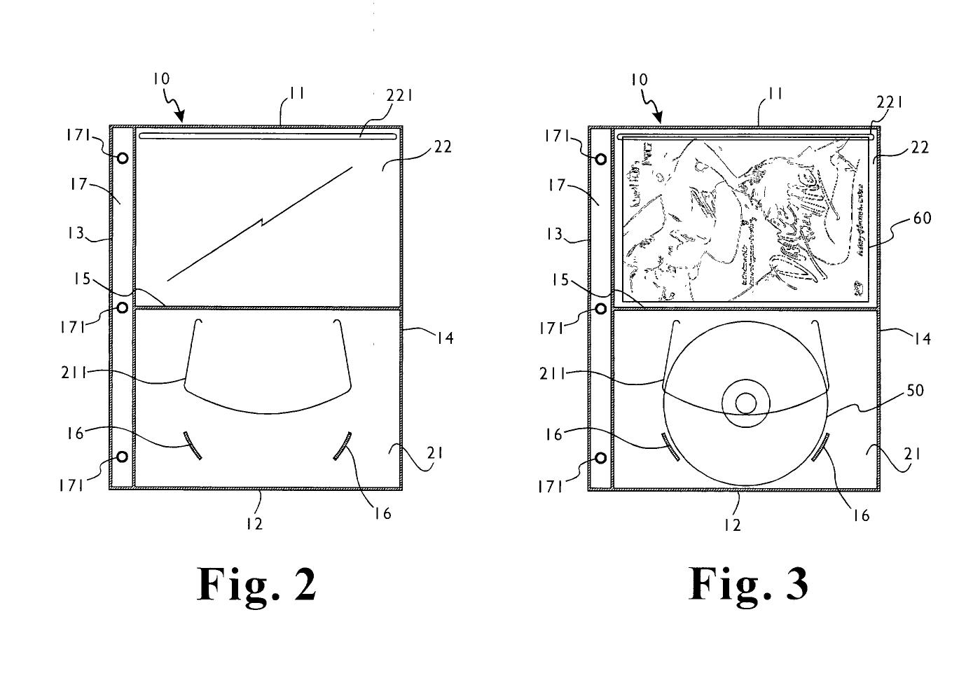

Please also refer to FIG. 2 and FIG. 3. The front transparent sheet 20, the middle sheet 30 and the back transparent sheet 40 each has an upper edge 11, a lower edge 12, a left edge 13 and a right edge 14. These three sheets 20, 30 and 40 are interconnected along their four edges 11, 12, 13 and 14, and a substantial midline 15 between their upper edge 11 and lower edge 12. Thus, a first disc pocket 21 and a first graphic pocket 22 are juxtaposedly formed between the front transparent sheet 20 and the middle sheet 30, and a second disc pocket 41 and a second graphic pocket 42 are juxtaposedly formed between the middle sheet 30 and the back transparent sheet 40.

Therefore, a record disc 50 and its accompanying graphics 60 can be held on the same side of the storage element 10 and seen through the transparent sheet 20 or 40. Such design allows a user to identify a target record disc 50 via its accompanying graphics 60 instantly and to access the target disc 50 at the same moment that the accompanying graphics 60 are found, without turning over the storage element 10. The backside of the storage element 10 which has identical structure also has the same advantage.

The first disc pocket 21, the first graphic pocket 22, the second disc pocket 41 and the second graphic pocket 42 have the same width which is slightly larger than the regular length of the accompanying graphics 60 and the same height which is slightly larger than the regular width of the accompanying graphics 60. Since the diameter of the record disc 50 is considerably smaller than the regular length of the accompanying graphics 60, the disc pockets 21 and 41 have an over-sized width which may allow the disc 50 to move along a disc pocket 21 or 41 between their left and right edges. To avoid this problem, two side stopping seals 16 are formed by interconnecting the front transparent sheet 20, the middle sheet 30 and the back transparent sheet 40 to hold the record disc 50 substantially at the middle portion of the disc pocket 21 or 41. To facilitate the manufacturing process, the first disc pocket 21 and the second disc pocket 41 are aligned back to back, whereby the side stopping seals 16 of the two pockets are aligned at same locations thus can be formed during a single process of jointly welding the three sheets 20, 30 and 40 at these locations.

The advantage of holding the disc 50 at the middle portion of the disc pocket 21 or 41 is to alleviate the impact of the difference of thickness between the portion occupied by a disc and the remaining portion of the disc pocket 21 and 41. With such design, the remaining portion which is not occupied by the record disc 50 is divided into two parts each having a reduced width.

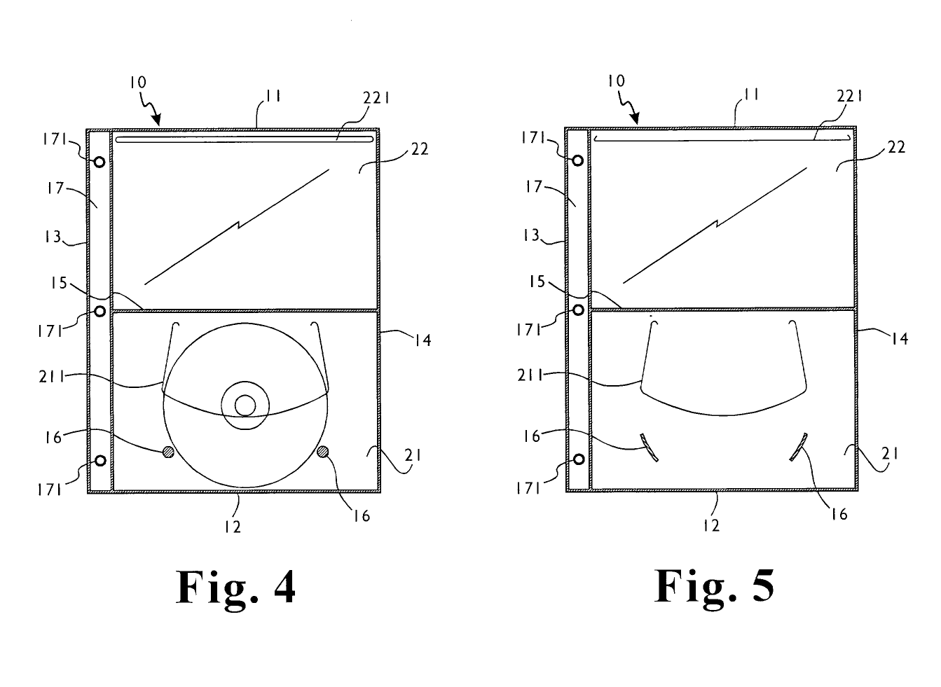

The side stopping seals 16 are disposed approximate to the lower half circumference of the disc 50 if loaded, and at a same elevated position from the bottom edge of the disc pockets 21 and 41, and preferably in a symmetrically diagonal fashion such that they can prevent the disc 50 from sideward movement but will not induce friction during removal or inserting of the disc 50. In another embodiment of the present invention as shown in FIG. 4, the side stopping seals 16 may alternatively be in a round shape, which preserves the same effect as mentioned above. To allow inserting and removal of the disc 50, flap cuts 211 and 411 are formed respectively at the upper middle portion of the disc pockets 21 and 41 on their constituent transparent sheets 20 and 40.

To allow inserting and removal of the graphics 60, elongated opening cuts 221 and 421 are formed respectively approximate to the upper edge of the graphic pockets 22 and 42 on their constituent transparent sheets 20 and 40. Thus, a record disc 50 and its accompanying graphics 60 are inserted into or removed from the pockets in the same upward direction. FIG. 5 shows an alternative shape of the opening cuts 221 and 421 each of which is fashioned with a very shallow flap structure.

The storage element 10 further comprises a binding portion 17 along the left edge 13, wherein several binding holes 171 are formed so that the storage element 10 becomes a loose-leaf sheet which can easily be coupled to and removed from a binding device (not shown). Alternatively, the binding portion 17 may comprise no binding hole but other means by which the storage element 10 can be connected to a binding device or a plurality of storage elements 10 can interconnect jointly.

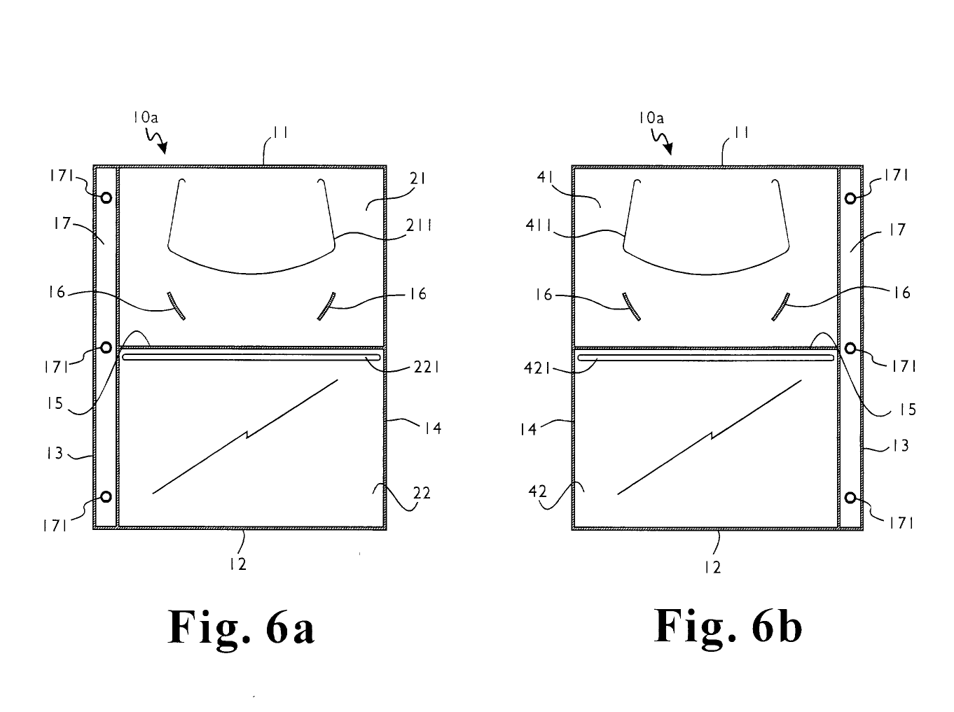

In the embodiments of the present invention shown in FIGS. 1-5 the disc pockets 21 and 41 are disposed at the lower portion of the storage element 10 and the graphic pockets 22 and 42 at its upper portion. FIGS. 6a-6b show the front and back elevation view of an alternative embodiment of the present invention wherein the disposition of the disc pockets 21 and 41, and the graphic pockets 22 and 42 in the storage element 10a is reversed and wherein the flap cuts 211 and the elongated opening cuts 221 remain close to the upper edge of the respective pockets.

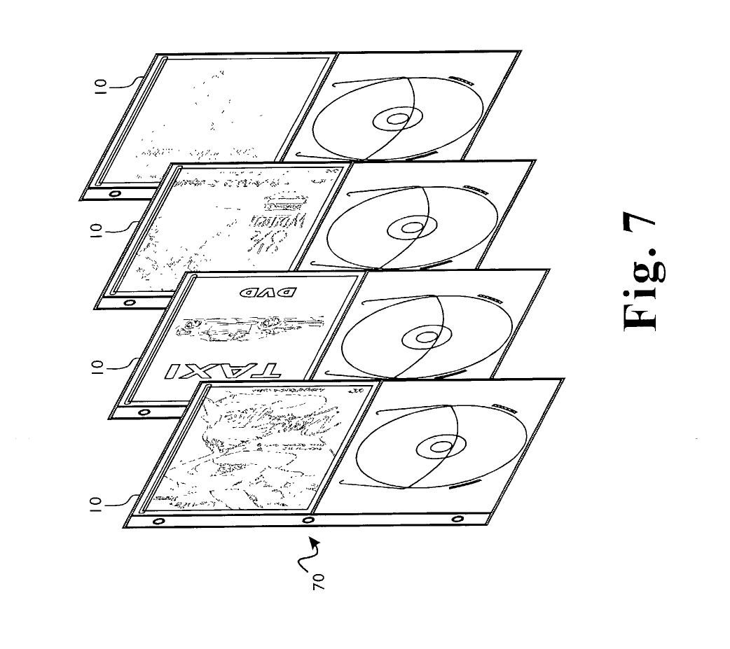

The most frequently used embodiments of the present invention may be those which comprise a plurality of storage elements 10 and/or 10a piled up and bound by a binding device thus forming an album which can store a great number of record discs 50 and their accompanying graphics 60. FIG. 7 shows a portion of a pre-assembled album 70 comprising a plurality of storage elements 10 and no storage element 10a, wherein the disc pockets 21 and 41 are disposed under the graphic pockets 22 and 42. Since the thickness of a record disc 50 such as a DVD, is generally greater than the total thickness of its accompanying graphics 60, the album 70 is not very space-efficient. Because when such album is fully loaded with discs 50 and graphics 60, its lower portion is stuffed with discs 50 while its upper portion still has many spaces.

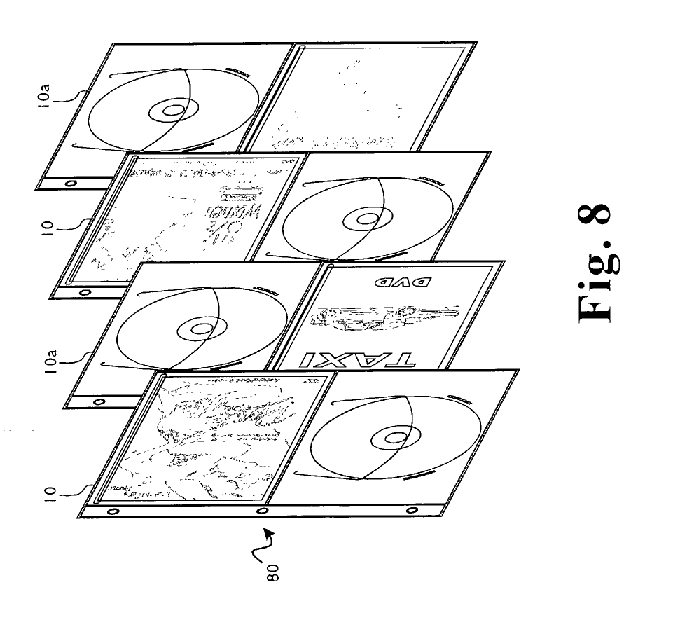

A more space-efficient embodiment of the present invention is depicted in FIG. 8, wherein the album 80 comprises substantially equal number of storage elements 10 and storage elements 10a. The storage elements 10 and 10a are preferably disposed in interposition. Because the disposition of the discs 50 and the graphics 60 in the storage elements 10 is reverse to that in the storage elements 10a, the difference of thickness between the discs 50 and the graphics 60 is neutralized with such interposed structure.

To give an example of the improvement by the design depicted in FIG. 8 over the design depicted in FIG. 7, comparative sample data are provided below: an album comprising one hard cover unit with 40 full loaded storage elements 10 only (or with 40 full loaded storage elements 10a only) has a total thickness of 5.25 inches while an album comprising one hard cover unit with 20 full loaded storage elements 10 and 20 full loaded storage elements 10a, arranged as shown in FIG. 8, is 3.5 inches thick. The space efficiency of the embodiment depicted by FIG. 8 is thus outstanding.

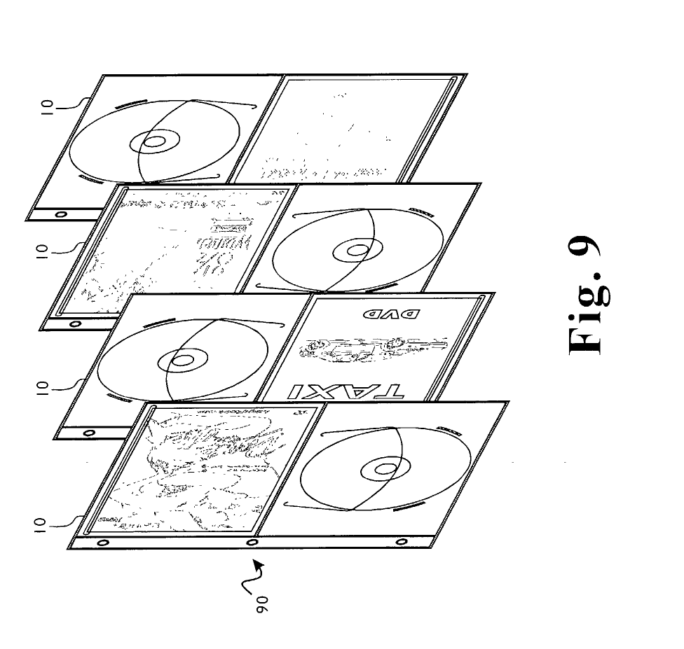

An alternative album embodiment to achieve the same space efficiency is to use only one kind of storage elements 10 or 10a. For example, please refer to FIG. 9, the album 90 comprises a plurality of storage elements 10 and no storage element 10a, wherein the storage elements 10 are arranged in pairs each having two storage elements 10 disposed in reverse directions.

1. A storage element adapted for holding two record discs having a diameter with a first length and their accompanying graphics having a second length substantially greater than the first length, comprising:
a front transparent sheet,
a middle sheet and
a back transparent sheet; each of said sheets having an upper edge, a lower edge, a left edge and a right edge;
said three sheets being interconnected along said four edges and a substantial midline between said upper and lower edges, wherein a first disc pocket and a first graphic pocket are defined between said front transparent sheet and said middle sheet, and a second disc pocket and a second graphic pocket are defined between said middle sheet and said back transparent sheet, said second disc pocket being in alignment with said first disc pocket and said second graphic pocket in alignment with said first graphic pocket;
two side stopping seals interconnecting said three sheets on said disc pockets for holding a record disc substantially in the center of each of said disc pockets and for preventing said record disc from moving sideward;
a first flap cut and a second flap cut formed respectively on said first disc pocket and said second disc pocket for allowing inserting and removal of said record discs;
a first elongated cut and a second elongated cut formed respectively on said first graphic pocket and said second graphic pocket for allowing inserting and removal of said graphics;
a binding portion where binding means are provided for coupling said storage element to a binding device.

2. The storage element of claim 1, wherein each of said elongated cuts has a third length which is greater than said second length of said graphics.

3. The storage element of claim 1, wherein each of said elongated cuts has a shallow flap structure.

4. The storage element of claim 1, wherein said side stopping seals are formed at a distance from an edge of said disc pockets opposite to the edge of said disc pockets approximate to said flap cuts.

5. The storage element of claim 4, wherein said distance is not greater than the radius of said record discs.

6. The storage element of claim 1, wherein said binding portion are located along said left edge.

7. The storage element of claim 1, wherein said disc pockets are disposed lower than said graphic pockets, said flap cuts are proximate to said substantial midline between said upper and lower edges, and said elongated cuts are proximate to said upper edge.

8. The storage element of claim 1, wherein said graphic pockets are disposed lower than said disc pockets, said elongated cuts are proximate to said substantial midline between said upper and lower edges, and said flap cuts are proximate to said upper edge.

9. An assembly of multiple storage elements, comprising:
at least a first storage element and
at least a second storage element, each of said first storage element and said second storage element further comprising:
a front transparent sheet,
a middle sheet and
a back transparent sheet, each of said sheets having an upper edge, a lower edge, a left edge and a right edge,
said three sheets being interconnected along said four edges and a substantial midline between said upper and lower edges, wherein a first disc pocket and a first graphic pocket are defined between said front transparent sheet and said middle sheet, and a second disc pocket and a second graphic pocket are defined between said middle sheet and said back transparent sheet, wherein said second disc pocket is in alignment with said first disc pocket and said second graphic pocket in alignment with said first graphic pocket;
two side stopping seals interconnecting said three sheets on said disc pockets for holding a record disc substantially in the center of each of said disc pockets and preventing said record disc from moving sideward;
a first flap cut and a second flap cut formed respectively on said first disc pocket and said second disc pocket for allowing inserting and removal of said record discs;
a first elongated cut and a second elongated cut formed respectively on said first graphic pocket and said second graphic pocket for allowing inserting and removal of said graphics;
a binding portion along said left edge where binding means are provided for coupling said storage element to a binding device;
wherein on said first storage element, said disc pockets are disposed lower than said graphic pockets, said flap cuts proximate to said substantial midline between said upper and lower edges, said elongated cuts proximate to said upper edge; and
on said second storage element, said graphic pockets are disposed lower than said disc pockets, said elongated cuts proximate to said substantial midline between said upper and lower edges, said flap cuts proximate to said upper edge; and
the number of said first storage elements substantially equals to the number of said second storage elements.

10. The assembly of claim 9, wherein said storage elements are piled up and disposed in such a manner that all of said upper edges thereof are in the same direction, and said first storage elements and said second storage elements are interposed.

11. An assembly of multiple storage elements of claim 1, wherein said storage elements are piled up and substantially half of said storage elements are disposed in such a manner that said upper edges thereof are in a first direction while other storage elements are disposed in such a manner that said upper edges thereof are in a second direction opposite to said first direction.

12. The assembly of claim 11, wherein said storage elements disposed in such a manner that said upper edges thereof are in the first direction and said other storage elements disposed in such a manner that said upper edges thereof are in the second direction are interposed.
